(19) United States
(12) Patent Application Publication
(10) Pub. No.: US 2008/0074503 A1
(43) Pub. Date: Mar. 27, 2008

(54) Camera device and title edit method in camera device

(75) Inventors: Shiro Nagaoka, Tokyo (JP); Kuniaki Takahashi, Tokyo (JP); Tatsuhiko Ikehata, Tokyo (JP); Kei Tashiro, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/902,139

(22) Filed: Sep. 19, 2007

(30) Foreign Application Priority Data
Sep. 27, 2006 (JP) 2006-263023

(51) Int. Cl. H04N 5/225

(52) U.S. Cl. 348/207.99; 348/E05.022

(57) ABSTRACT

According to one embodiment, a camera device includes; a moving image data generating device generating moving image data with preceding data, which has moving image data indicating a shot video and preceding data thereof indicating a preceding image reproduced prior to the moving image data; a title data generating device generating title data indicating a title to be inserted into the moving image data with preceding data; and a data replacement unit replacing data for title insertion having the data size as of the title data of the preceding data in the moving image data with preceding data with the title data generated by the title data generating device.

### CROSS-REFERENCE TO RELATED APPLICATIONS

This application is based upon and claims the benefit of priority from Japanese Patent Application No. 2006-263023, filed Sep. 27, 2006, the entire contents of which are incorporated herein by reference.

### BACKGROUND

1. Field

One embodiment of the invention relates to a camera device provided with a function of inserting a title into moving image data indicating a shot video, such as a digital camera, a video camera or so forth, and a title edit method in the camera device.

2. Description of the Related Art

Conventionally, there is known a camera device (also called an electronic camera device) importing an optical image of a subject as a still image or a moving image, converting the shot image into image data and electronically save it. Conventional camera devices include a digital camera mainly shooting the still image and a video camera mainly shooting the moving image.

Conventionally, a variety of the digital cameras and video cameras are widely spread, and among them, there is a camera device provided with a function of inserting a title into the moving image data.

For instance, in Japanese Patent Application Publication (KOKAI) No. 2000-307957 (Patent document 1), there is disclosed a video camera in which a title insertion and change is realized without changing moving image data being a master by way of storing still image data for title in file management information of the moving image data and updating the file management information.

Further, in Japanese Patent Application Publication (KOKAI) No. 2001-333377 (Patent document 2), there is disclosed a video camera designed to read out selected title information from a memory element memorizing a variety of title information to thereby insert the information into moving image data at a desired timing.

Furthermore, in Japanese Patent Application Publication (KOKAI) No. 7-131710 (Patent document 3), there is disclosed a video camera designed to mix a title area signal making a title image by enlarging a title area displaying a title to the fullest extent in a screen and a shot image signal.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing main components of a camera device according to an embodiment of the invention;

FIG. 2 is an exemplary view showing data structure of moving image data compressed by a compression/decompression unit in compliant with MPEG-2 in the embodiment;

FIG. 3 is an exemplary view showing the data structure of the moving image data compressed by the compression/decompression unit in compliant with MPEG-2 in the same manner as in FIG. 2 by showing GOPs in the embodiment;

FIG. 4 is an exemplary view showing a structure of moving image data with preceding data in the embodiment by showing GOPs;

FIG. 5 is an exemplary view showing a structure of title data in the embodiment;

FIG. 6 is an exemplary view schematically showing a title insertion procedure in the embodiment;

FIG. 7 is an exemplary flowchart showing an operation procedure of a title insertion process in the embodiment:;

FIGS. 8A and FIG. 8B are exemplary views showing a structure of the moving image data before a pre-cut edit in the embodiment by showing GOPs, in which FIG. 8A is a view before a cut point is designated and FIG. 8B is a view after the cut point is designated; and

FIG. 9 is an exemplary view showing the insertion procedure of the title data into the moving image data when the pre-cut edit is performed.

### DETAILED DESCRIPTION

Various embodiments according to the invention will be described hereinafter with reference to the accompanying drawings. In general, according to one embodiment of the invention, a camera device includes: a moving image data generating device generating moving image data with preceding data having moving image data indicating a shot video and the preceding data indicating a preceding image reproduced prior to the moving image data; a title data generating device generating title data indicating a title to be inserted into the moving image data with preceding data; and a data replacement unit performing a data replacement replacing data for title insertion having the same data size as of the title data of the preceding data in the moving image data with preceding data with the title data generated by the title data generating device.

Further, in a title edit method in the camera device, title data indicating a title to be inserted into moving image data with preceding data is generated and the data for title insertion having the same data size as of the title data of the preceding data in the moving image data with preceding data is replaced with the title data generated.

(Components of camera device)

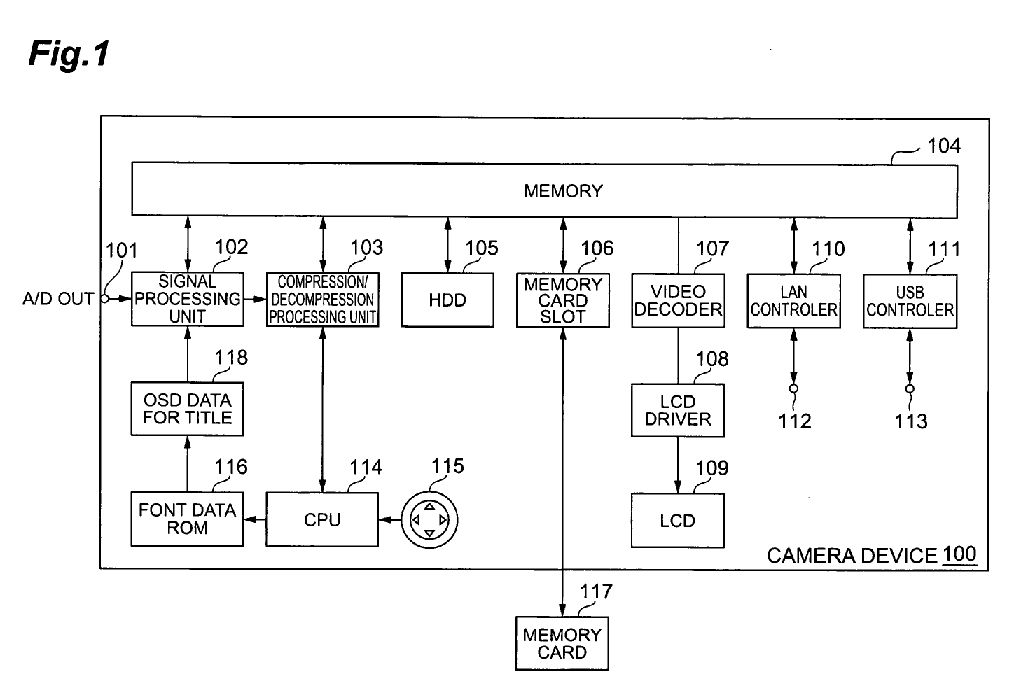

FIG. 1 is a block diagram showing main components of a camera device 100 according to the embodiment of the invention. The camera device 100 shown in FIG. 1 is a digital video camera device shooting mainly a moving image but capable of shooting a still image.

The camera device 100 includes a digital signal output unit 101, a signal processing unit 102, a compression/decompression processing unit 103 and a working memory 104 and a HDD (Hard Disk Drive) 105.

Further, the camera device 100 includes a memory card slot 106, a video decoder 107, an LCD (Liquid Crystal Display) driver 108, an LCD 109, a LAN controller 110 and a USB controller 111. Furthermore, the camera device 100 includes a LAN terminal 112, a USB terminal 113, a CPU 114, an operation unit 115 and a font data ROM 116.

The digital signal output unit 101 converts an analog electric signal, which is generated by a CCD (Charge Coupled Device) using an optical image of a subject obtained through a not-shown lens, into a digital signal to output it to the signal processing unit 102.

The signal processing unit 102 performs an image processing to the inputted digital signal to thereby generate moving image data indicating a shot video actually shot. Further, the signal processing unit 102 has a function as a moving image data generating device and, when generating the moving image data, generates later-described moving image data with preceding data being the generated moving image data added with later-described preceding data. Note that the generated moving image data is once stored in the memory 104.

The compression/decompression processing unit 103 compresses the moving image data exported from the memory 104 in compliant with MPEG-2 to thereby produce compressed moving image data, or compresses still image data in compliance with JPEG to produce compressed still image. Further, in accordance with an instruction of the CPU 114, the compression/decompression processing unit 103 decompresses the compressed moving image data and the compressed still image data.

The memory 104 temporarily memorizes data to be a processing target of the signal processing unit 102 and data to be a processing target of the compression/decompression processing unit 103.

The HDD 105 is an external memory device recording the moving image data and the sound data compressed in a HD (Hard Disc) built therein. The HDD 105 reads/writes data with respect to the HD (Hard Disc) based on a random access.

A memory card 117 such as an SD memory card (Secure Digital memory card) is inserted into the memory card slot 106, and the memory card slot 106 reads/writes data with respect to the memory card 117 inserted thereinto.

In order to display the shot video that is shot using the compressed moving image data, the video decoder 107 performs a decoding process to the moving image data to thereby output it to the LCD driver 108. The video decoder 107 is a software decoder realized by a decoding program.

The LCD driver 108 converts the decoded moving image data received from the video decoder 107 into a display signal compatible with an interface of the LCD 109. The LCD 109 displays the shot video using the display signal outputted from the LCD driver 108.

In accordance with the instruction of the CPU 114, the LAN controller 110 transfers the image data obtained from the memory 104 to a not-shown external device (for example, a DVD decoder or an HDD recorder) connected via the LAN terminal 112. Besides, the LAN controller 110 outputs the moving image data imported from the external device via the LAN terminal 112 to the memory 104.

In accordance with the instruction of the CPU 114, the USB controller 111 transfers the moving image data obtained from the memory 104 to a not-shown external device (for example, a personal computer) connected via the USB terminal 113. Besides, the USB controller 111 outputs the moving image data imported from the external device via the USB terminal 113 to the memory 104.

In accordance with a program memorized in a not-shown ROM, the CPU 114 operates as various units (a data replacement unit, an area securing unit) being a feature of the embodiment. Further, the CPU 114 inputs/outputs a signal into/from the other component to control the entire operation or the respective sequences of the camera device 100.

The operation unit 115 is a selective operation device carrying a jog dial and a cross key with which a user selects various functions (for example, start or stop of the shooting, reproduction of the shot video, and the like) in the camera device 100 or selects whether or not to secure a later-described title insertion area. Further, the operation unit 115 also operates as an operating input device, with which the user performs an operating input of the title, and further includes a function as an edit device to perform a later-described a pre-cut edit.

The font data ROM 116 memorizes font data such as a plurality of texts and symbols composing the title to be inserted into the moving image data with preceding data.

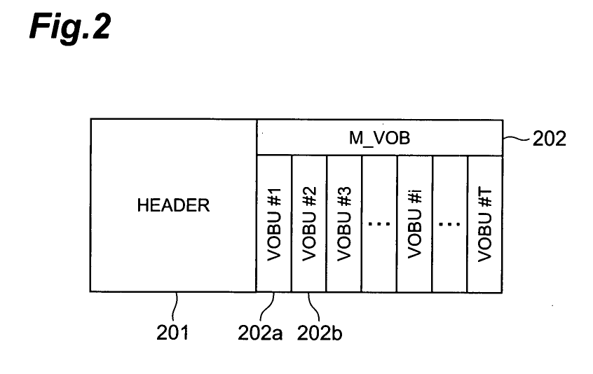

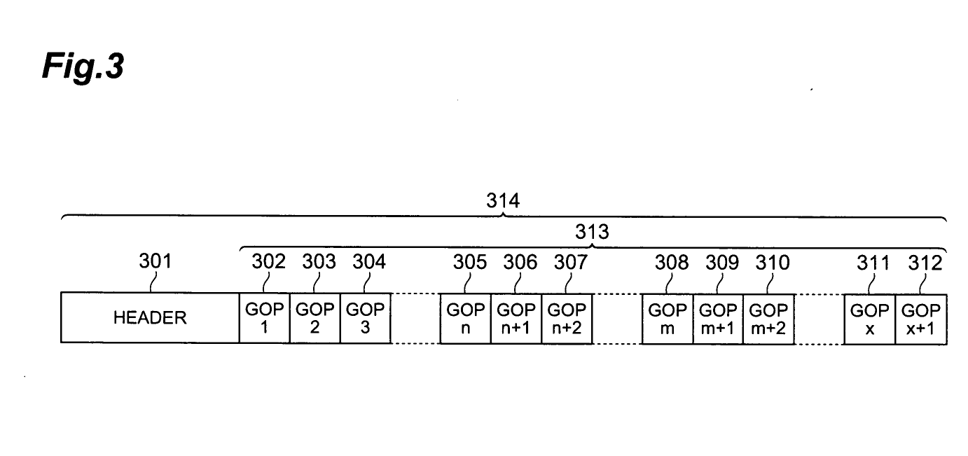

Subsequently, the data structure of the moving image data compressed in compliance with MPEG-2 by the compression/decompression processing unit 103 will be described with reference to FIG. 2 and FIG. 3. Here, FIG. 2 is a view showing the data structure of the moving image data compressed in compliance with MPEG-2 by the compression/decompression processing unit 103. The moving image data includes a header section 201 and a data section 202. In the header section 201, information including each size of respective VOBs (Video Object Unit) composing the data section 202 is provided in accordance with the number of later-described GOPs (Group of Pictures). In the data section 202, a plurality of the VOBs (VOB202a, 202b. . . ) is provided.

Further, similarly, FIG. 3 is a view showing the structure of moving image data 314 compressed in compliance with MPEG-2 by the compression/decompression processing unit 103 by showing GOPs. When reproducing the shot video using the moving image data 314, in the camera device 100, it is possible to reproduce the moving image separately for each unit by combining a certain unit of the moving image or a certain pieces of the moving images into the GOP. The GOP includes the moving image data corresponding to 15 flames.

The moving image data 314 includes a header 301 and moving image data 313 indicating a shot video actually shot. The header 301 includes initial data necessary for the video decoder 107 to decode and reproduce the shot video, such as the size of the image, a pixel aspect ratio and so forth. The moving image data 313 is structured as a data stream having a plurality of GOPs (GOP302 to 312). Each of the GOPs is a unit of an edit process using the operation unit 115.

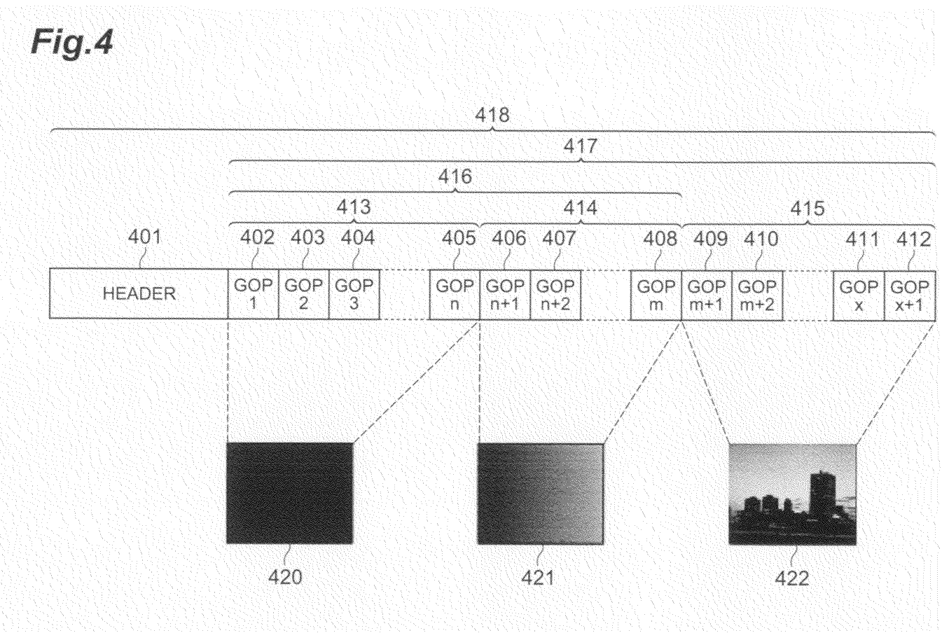

Further, FIG. 4 is a view showing the structure of moving image data with preceding data 418 by showing the GOPs. The moving image data with preceding data 418 includes a same header 401 as the header 301 and an actual data 417 having preceding data 416 and moving image data 415 indicating a shot video 422 actually shot.

The moving image data 415 is structured as a data stream having the same plurality of GOPs (GOP409 to 412) as of the moving image data 313. The preceding data 416 includes the plurality of GOPs (GOP402 to 408) and added to a beginning portion of the moving image data 415 so that the preceding data 416 is reproduced prior to the moving image data 415 when reproducing the shot video using the moving image data with preceding data 418.

The preceding data 416 includes dummy title data 413 at a beginning portion thereof and changing video data 414 arranged between the dummy title data 413 and the moving image data 415.

The dummy title data 413 includes the plurality of GOPs (GOP402 to 405) and is data to display a video for preliminary display (a preliminary video displayed in the same color for a certain time) 420 so as to reproduce the shot video. This dummy title data 413 is data to display the preliminary video, and, on top of that, it is data for title insertion into which a title is inserted.

The changing video data 414 includes the plurality of GOPs (GOP406 to 408) and is data to display a video (changing video) 421 showing a scene in which the preliminary video becomes the shot video in a gradually changing manner by a so-called fade-in. Note that the preliminary video 420 and the changing video 421 compose a preceding video.

In the camera device 100, when generating the moving image data, it is possible to select to generate either the moving image data 313 or the moving image data with preceding data 418, namely whether or not to secure a title insertion area to insert the title prior to the moving image data can be selected. This selection can be performed, for example, by operating the operation unit 115 along with a menu screen displayed in the LCD 109. When the user selects to secure the title insertion area, a flag (title insertion flag) indicating the fact is set, and the CPU 114 generates the moving image data with preceding data 418 when this title insertion flag is set.

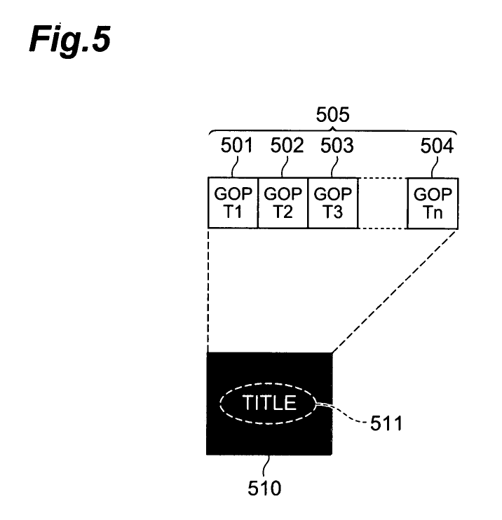

Further, FIG. 5 is a view showing the structure of title data 505. The title data 505 is data to display a title video 510 indicating a title 511 set by a later-described title input operation performed by the user using the operation unit 115.

The title data 505 includes a plurality of GOPs (GOP501 to GOP504) and is generated to have the same data size as of the dummy title data 413. Specifically, the number of GOPs composing the title data 505 is structured to be equal to the number of the GOPs composing the dummy title data 413.

(Operation details of camera device)

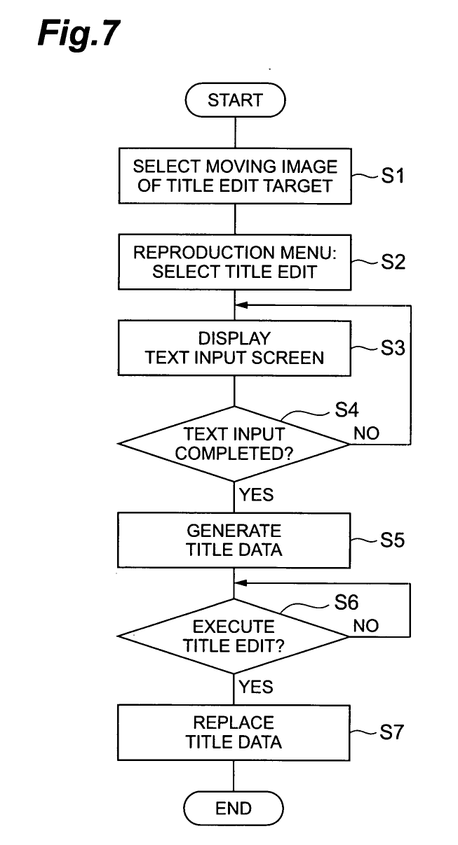

Subsequently, the description will be give of an operation procedure of the title insertion process by the camera device 100. FIG. 7 is a flowchart showing the operation procedure of the title insertion process. The title insertion process is executed under the control of the CPU 114.

When the title insertion process is started, the CPU 114 puts the process forward to block 1 to let the user select the moving image data to be a target of the title insertion from among the already-shot moving image data. In this case, the CPU 114 displays a listing of the already-shot moving image data on the LCD 109 to enable the user to select a desired moving image data using the operation unit 115.

Subsequently, when the moving image data is selected, the CPU 114 puts the process forward to block 2 to determine based on a reproduction menu displayed on the LCD 109 whether or not a “title edit” is selected and when the “title edit” is selected, then the CPU 114 puts the process forward to block 3 and displays a text input screen on the LCD 109 (the title insertion into the moving image data is called the title edit).

Here, the user inputs the title (for example, an “athletic meet”, a “wedding ceremony” and so forth) that the user intends to insert into the moving image data by operating the operation unit 115 while referring to the text input screen. Subsequently, the CPU 114 puts the process forward to block 4 to determine whether or not the text input for the title input is completed, and when the text input is completed, puts the process forward to block 5. In block 5, the CPU 114 generates OSD data 118 for title indicating the title inputted by the end of block 4 and instructs the signal processing unit 102 to generate the title data 505. Then, the signal processing unit 102 operates to let the memory 104 memorize the title data 505.

Subsequently to block 5, the CPU 114 puts the process forward to block 6, waits until the operating input of a “title edit execution” using the operation unit 115 is performed, and, when the operation of the “title edit execution” is performed, puts the process forward to block 7. When the CPU 114 puts the process forward to block 7, the CPU 114 performs an operation as a data replacement unit to execute a data replacement process.

At this time, the CPU 114 replaces the data in the manner as described below and replaces the dummy title data 413 in the moving image data with preceding data 418 with the title data 505 generated in block 5.

The moving image data with preceding data 418 is memorized in the HDD 105, while the data is read/written from/into the HDD 105 based on the random access. Therefore, the CPU 114 accesses to an area in the HDD 105 in which the dummy title data 413 of the moving image data with preceding data 418 selected in block 1 is memorized and replaces the dummy title data 413 with the title data 505 (overwrites the dummy title data 413 with the title data 505).

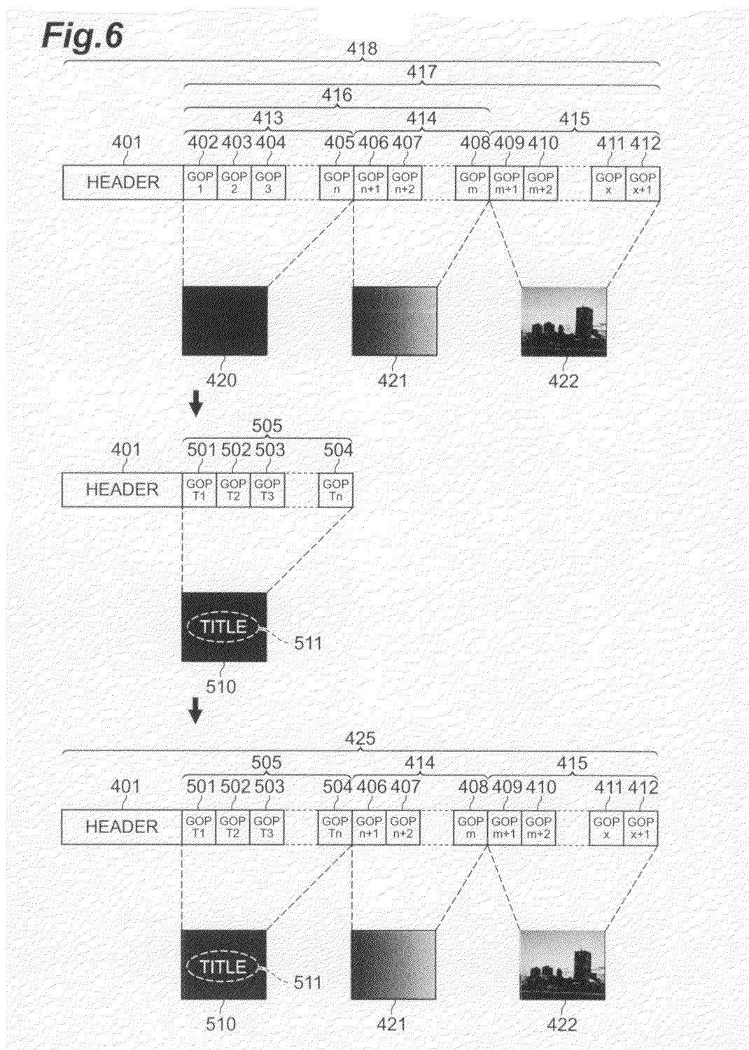

Since the dummy title data 413 and the title data 505 have the same data size, with the data replacement as described above, as shown in FIG. 6, the dummy title data 413 is replaced with the title data 505, and moving image data with title 425 into which the title is inserted can be obtained.

The moving image data with title 425 has the title data 505 prior to the moving image data. Therefore, when performing the reproduction process using the moving image data with title 425, after the title video 510 is displayed, the changing video 421 is displayed backed by the fade-in and, subsequently, the shot video 422 is displayed. Incidentally, the CPU 114 ends the title insertion process when it executes block 7.

Subsequently, the description will be given of a title insertion in the case where a precedent cut edit (pre-cut edit) cutting the preceding area being reproduced earlier among the moving image data is performed.

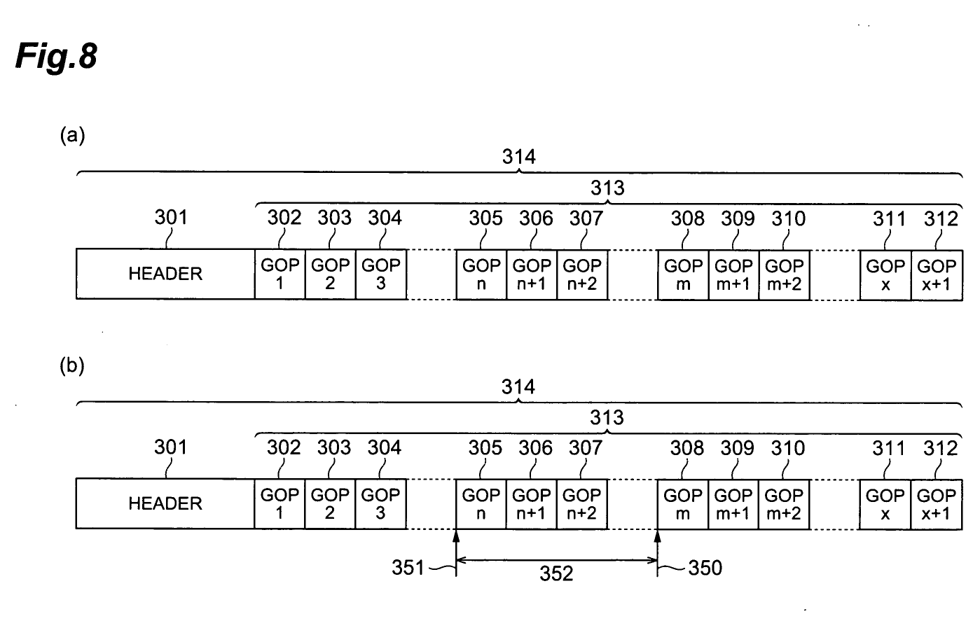

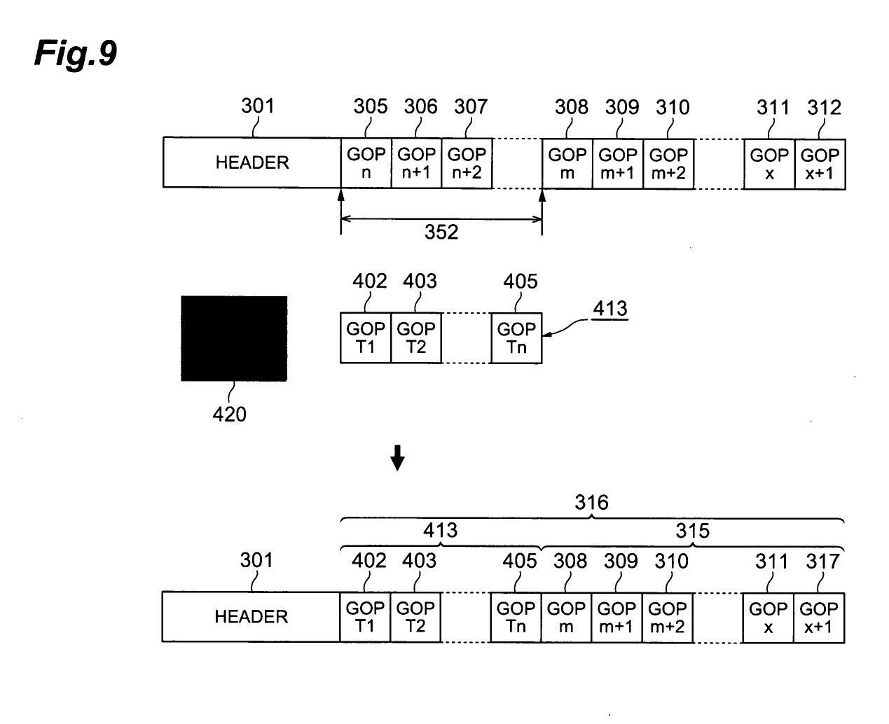

FIGS. 8A and FIG. 8B are views showing a structure of the moving image data 314 before a pre-cut edit by showing GOPs, in which FIG. 8A is a view before a cut point is designated and FIG. 8B is a view after the cut point is designated. FIG. 9 is a view showing an insertion procedure of title data 515 into the moving image data 314.

First, it is assumed that the user performs the pre-cut edit with respect to the above-described moving image data 314 by operating the operation unit 115. When this pre-cut edit is performed, by the operating input of the operation unit 115 by the user, the cut point (also called an edit point) 350 of the moving image data 314 is designated. When the cut point 350 is designated, the CPU 114 is to cut the preceding area of the cut point 350. Accordingly, all the video shown by the GOPs arranged prior to the cut point 350 become unnecessary.

Therefore, after the cut point 350 is designated in a manner as shown in FIG. 8B, in the case where the title insertion is performed, the CPU 114 performs an operation as an area securing unit and shifts the cut point 350 to a cut point 351 prior thereto to secure a data area for title insertion 352 prior to the cut point 350 to insert the title data 505. In this case, the CPU 114 lets the data area for title insertion 352 and the title data 505 have the same data size.

Then, as shown in FIG. 9, such data (GOP305, 306, 307, . . . ) that correspond to the data area for title insertion 352 is replaced with the dummy title data 420. After that, the CPU 114 just executes the data replacement process of block 7 in the manner similarly to the above to thereby replace the dummy title data 420 with the title data 505.

By doing so, moving image data with title 316 which the title inserted in the moving image data 315 after the pre-cut edit can be obtained.

As has been described, the camera device 100 replaces only the dummy title data 413 with the title data 505, so that the title can be inserted into the moving image data without changing the moving image data indicating the actual shot video at all. Since the dummy title data 413 and the title data 505 have the same data size, the moving image data is not affected at all even when the data replacement process is performed as described above.

Further, the camera device 100 replaces only the dummy title data 413 of the moving image data with preceding data 418 with the title data 505 without reading/writing the moving image data 415 having a large data volume, so that the title insertion can be performed in an extremely short time.

Besides, in the camera device 100, the moving image data with preceding data 418 is memorized in the random-access capable HDD 105, so that the title insertion can be realized by replacing the dummy title data 413 only. Accordingly, for inserting the title, neither the recompression of the moving image data 415 nor decoding of the compressed moving image data 415 is necessary. Therefore, no memory having a huge volume is required for inserting the title and the image quality does not degrade.

Further, the camera device 100 does not need to prepare the separate chips for the compression process and the decoding process, respectively, so that a power consumption increase, a cost increase and a large heat generation are not caused.

Since the moving image data and the title are formed as a single data, the both can be reproduced together and surely even in the other device.

It should be noted that the above-described camera device 100 is provided with the HDD 105 as an external memory device capable of writing/reading data based on the random access, however, other than the HDD 105, a DVD drive recoding data into a DVD (Digital Versatile Disk) may be provided. Then, it goes well when the moving image data is memorized in a rewritable memory media such as DVD-RW, DVD-RAM and the like by the DVD drive.

The description in the above is to describe the embodiments of the invention and, in no case, limits the device and method of the invention, so that various modifications can be embodied with ease. Further, the device and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A camera device comprising:
a moving image data generating device generating moving image data with preceding data having moving image data indicating a shot video and preceding data indicating a preceding image reproduced prior to the moving image data;
a title data generating device generating title data indicating a title to be inserted into the moving image data with preceding data; and
a data replacement unit performing a data replacement replacing data for title insertion having a same size as of the title data of the preceding data in the moving image data with preceding data with the title data generated by said title data generating device.

2. The camera device according to claim 1, further comprising:
an edit device to perform a pre-cut edit cutting such a preceding area that is reproduced earlier among the moving image data; and
an area securing unit securing a title insertion area to insert the title data prior to an edit point designated by said edit device,
wherein said data replacement unit replaces corresponding data corresponding to the title insertion area secured by said area securing unit, as the data for title insertion, with the title data generated by said title data generating device.

3. The camera device according to claim 1,
wherein said moving image data generating device is structured to generate the moving image data with preceding data as a changing video data indicating a changing video gradually changing between the data for title insertion and the moving image data by defining a beginning portion of the preceding data as the data for title insertion.

4. The camera device according to claim 1, further comprising an external memory device memorizing the moving image data with preceding data generated by said moving image data generating device and writing and reading data based on a random access,
wherein said data replacement unit performs the data replacement by replacing the data for title insertion of the moving image data with preceding data memorized in said external memory device with the title data.

5. The camera device according to claim 1, further comprising an operating input device performing an operating input of the title,
wherein said title data generating device is structured to generate a title display data indicating the title inputted by said operating input device as the title data.

6. The camera device according to claim 1,
wherein said moving image data generating device is structured to generate the moving image data with preceding data in a manner that the data for title insertion is generated to have the data size of integral multiple of a GOP being a unit of a compression process.

7. The camera device according to claim 1, further comprising a selective operation device to select to secure a title insertion area to insert the title data prior to the moving image data or not.

8. The camera device according to claim 5,
wherein said title data generating device is structured to generate the title data to have a same data size as of the data for title insertion.

9. A title edit method in a camera device including a moving image data generating device generating moving image data with preceding data having moving image data indicating a shot video and preceding data indicating a preceding image reproduced prior to the moving image data,
wherein title data indicating a title inserted into the moving image data with preceding data is generated, and
wherein a data replacement replacing data for title insertion having a same data size as of the title data of the preceding data in the moving image data with the title data is performed.

10. A title edit method
wherein moving image data with preceding data generated by a moving image data generating device is memorized in an external memory device reading/writing data based on a random access, and
a data replacement is performed by overwriting data for title insertion of the moving image data with preceding data memorized in the external memory device with the title data.
